(19) United States
(12) Patent Application Publication
(10) Pub. No.: US 2019/0027785 A1
(43) Pub. Date: Jan. 24, 2019

(54) ELECTROLYTE SOLVENTS AND ADDITIVES FOR ADVANCED BATTERY CHEMISTRIES

(71) Applicants: Arthur von Wald Cresce, Silver Spring, MD (US); Selena M. Russell, Wheaton, MD (US); Kang Xu, Potomac, MD (US)

(72) Inventors: Arthur von Wald Cresce, Silver Spring, MD (US); Selena M. Russell, Wheaton, MD (US); Kang Xu, Potomac, MD (US)

(73) Assignee: THE UNITED STATES GOVERNMENT AS REPRESENTED BY THE SECRETARY OF THE ARMY, WASHINGTON, DC (US)

(21) Appl. No.: 15/657,311

(22) Filed: Jul. 24, 2017

(51) Int. Cl. H01M 10/0569; H01M 10/0567; H01M 10/0525; H01M 4/587; H01M 4/505; H01M 4/525; H01M 2/16

(52) U.S. Cl. CPC H01M 10/0569; H01M 10/0567; H01M 10/0525; H01M 2300/0028; H01M 4/505; H01M 4/525; H01M 2/1653; H01M 4/587

(57) ABSTRACT

Nonaqueous electrolyte solvents or additives include components synthesized for advanced rechargeable batteries using diversified chemistries to achieve high energy densities. The electrolyte components are generated to create the formation of protective interphases on both cathode and anode surfaces simultaneously. The electrolyte components integrate the key structural elements into a single molecule, thus rendering the stabilization of electrode/electrolyte interfaces more efficiently and with parasitic reactions minimized. The electrolyte components have several applications in diversified battery chemistries such as Li-ion of high voltage and high capacity as well as beyond Li-ion (e.g., Li/sulfur, Na and Mg ion as well as conversion-reaction).

### GOVERNMENT INTEREST

The embodiments herein may be manufactured, used, and/or licensed by or for the United States Government without the payment of royalties thereon.

### BACKGROUND

### Technical Field

The embodiments herein generally relate to nonaqueous electrolytes that improve the performance of advanced battery chemistries, including Li-ion batteries and beyond Li-ion batteries that involve conversion-reaction type cathode materials or other cation intercalation chemistries such as sodium or magnesium ions, and more particularly to solvents and additives that form the nonaqueous electrolytes and can simultaneously form protective interphasial layers on both anode and cathode surfaces.

### Description of the Related Art

Rechargeable batteries that output high cell voltages (>3.0 V) utilize nonaqueous and aprotic solvents to dissolve the conducting salts, because these solvents are able to afford the stability against the oxidative or reductive reactions incurred by electrode surfaces of extreme potentials. Because the electrolyte components are almost never thermodynamically stable on the strongly reductive surfaces of anode or strongly oxidative surfaces of cathode, the electrochemical stability is attained through the passivation of the electrode surfaces. The above passivation is realized by the initial decompositions of solvents in trace amount and the subsequent deposition of these decomposition products which deactivate the catalytic sites of the electrode surfaces. Almost universally in all electrochemical devices that produce cell voltages higher than 3.0 V, and particularly in Li-ion battery chemistries, certain solvents were developed in the industry so that their decomposition products on anode and cathode surfaces are able to form dense and protective interphasial layers. These solvents include ethylene carbonate (EC), vinylene carbonate (VC) and other polar and aprotic solvents and/or additives, and have become the indispensable components in all commercial Li-ion batteries.

However, the passivation formed by the above-described solvents and/or additives in state-of-the-art electrolytes meets severe challenges when new cathode or anode materials are introduced into the advanced rechargeable batteries to achieve higher energy density. Such advanced electrode materials either operate at very high potentials (>4.5 V), or experience dynamic phase changes during each electrochemical cycling, or involve multiphase reactions. The conventional electrolyte and additive typically cannot form effective stabilization and protection on surfaces of these new battery chemistries; therefore new electrolyte components have to be developed.

The state-of-the-art approach to develop new electrolyte components often takes a trial-and-error pathway, randomly testing and screening a vast number of structures against an individual electrode surface, and after accumulating certain level of data and confidence, selecting the best performing candidates. However, intrinsic flaws of such empirical approaches exist; i.e., (1) there is no accurate understanding on fundamental level why certain molecules work (or do not work) on an electrode surface, so that future efforts can be made based on certain rational guidelines; and (2) these additives are often evaluated against a single electrode surface, without considering the fact that once present in electrolyte system, each of the component will interact with both electrode surfaces simultaneously. This is why in most cases a good additive developed for a cathode surface fail to deliver expected performances once placed in a full rechargeable cell. This is also why in most cases a “cocktail” of different additives have to be used in a single electrolyte solution, making the eventual performance complicated to understand and less effective as result of cross-reactions among various additives and electrode surfaces.

Hence, any effective electrolyte component for the above-mentioned advanced battery chemistries should be rationally designed with a solid knowledge basis, and should consider the fact that it would function as protection provider for both anode and cathode surfaces.

### SUMMARY

In view of the foregoing, an embodiment herein provides an electrochemical cell comprising a negative electrode comprising any of a metal, a metal alloy, and an electrode active material; a positive electrode comprising an electrode active material; a membrane separating the negative electrode from the positive electrode; and a nonaqueous electrolyte solvent or additive comprising molecules having a structure of any of formulas I through V:

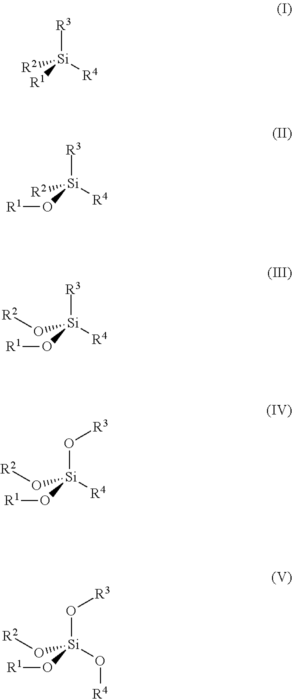

wherein R^{1˜4} are independently selected from the following four groups of structural elements: (1) unsaturated radicals, (2) mono- or polyhalogenated alkyl radicals; (3) carbonyl moieties; or (4) halogen radicals. The cations may comprise any of Li⁺, Na⁺, Mg²⁺, Ca²⁺, and Al³⁺.

The unsaturated radicals may comprise any of allyls, propargyls, vinyls, and acetylenyls. The mono- or polyhalogenated alkyl radicals may comprise any of trifluoromethyl, trifluoroethyl, hexafluoro-iso-propyl, hexafluoro-isopropyl-2-methyl, and perfluoro-tert-butyl. The carbonyl moieties may comprise any of methyl carboxyl and methy formyl. The halogen radicals may comprise fluorine. The nonaqueous electrolyte solvent or additive may only comprise the molecules. The electrochemical cell may further comprise a cosolvent mixed with the nonaqueous electrolyte solvent or additive, wherein the cosolvent comprises any of cyclic and acyclic carbonates and carboxylic esters, and fluorinated cyclic and acyclic carbonates and carboxylic esters.

The electrochemical cell may further comprise any of ethylene carbonate, propylene carbonate, vinyl carbonate, dimethyl carbonate, diethyl carbonate, ethylmethyl carbonate, γ-butyrolactone, methyl butyrate, ethyl butyrate, and mixtures thereof. The electrochemical cell may further comprise any of fluoroethylene carbonate and 1,1,1-trifluoroethylmethyl carbonate. The Li⁺ may comprise any of lithium hexafluorophosphate, lithium fluoro(perfluoroalkyl)phosphate, lithium tetrafluroborate, lithium hexafluroarsenate, lithium perchlorate, lithium tetrahloaluminate, lithium tris(trifluoromethanesulfonyl)methide, lithium perfluoroalkylsulfonate, lithium arylsulfonate, lithium bis(oxalato)borate, lithium difluoro(oxalato)borate, and mixtures thereof.

The negative electrode may comprise an active material comprising any of a lithium metal and a lithium alloy with other metals comprising any of silicon, tin, carbonaceous materials with various degree of graphitization, lithiated metal oxides, and chalcogenides. The positive electrode may comprise an active material comprising any of transition metal oxides, metal halides, metalphosphates, chalcogenides, and carbonaceous materials with various degree of graphitization, sulfur-based cathode materials embedded or confined in various meso- or micropores of carbon hosts. Any of the nonaqueous electrolyte solvent or additive, and the cosolvent may comprise a concentration of approximately 0.005% to 100% with respect to a total solvent weight. The Li⁺, Na⁺, Mg²⁺, Ca²⁺, and Al³⁺ may comprise a concentration of approximately 0.5-3.0 mole/liter.

The negative electrode may reversibly intercalate/de-intercalate cations voltage potentials less than 2V. The positive electrode may reversibly intercalate/de-intercalate cations and experiences reversible conversion-reactions. The structural elements may comprise a structure of any of formulas VI through X:

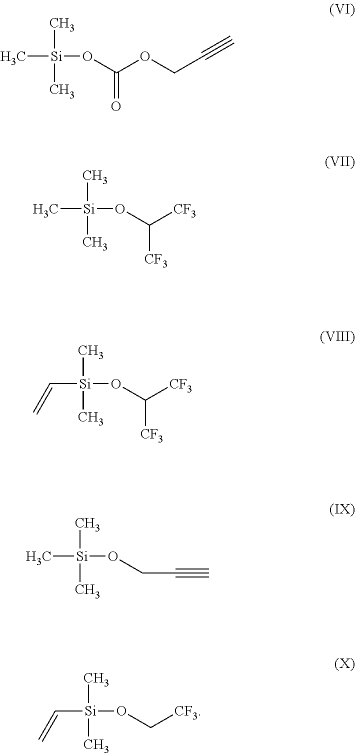

The membrane may comprise a porous polyolefin separator. The membrane may comprise a gellable polymer film.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a graph illustrating the results of “floating tests” of different electrolyte solutions in a high voltage Li-ion cell comprising graphite as an anode and LiNi_{0.5}Mn_{1.5}O₄ as a cathode according to the embodiments herein;

FIG. 2 is a graph illustrating the results of “cycling tests” of different electrolyte solutions in a high voltage Li-ion cell comprising graphite as an anode and LiNi_{0.5}Mn_{1.5}O₄ as a cathode according to the embodiments herein; and

FIG. 3 is a schematic diagram of an electrochemical cell according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein are described in accordance with certain terminology defined below. However, it is to be understood that the terminologies used herein are for the purpose of describing particular embodiments only, and are not intended to be limiting. As used herein:

“Silane” refers to Si connected with at least two carbon atoms;

“Siloxane” refers to Si connected with at least one oxygen atom;

“Unsaturation” refers to either double or triple bond between carbon and carbon atoms;

“Mono-” or “highly halogenated” alkyl refers to alkyl moieties on which one or more hydrogens are replaced by halogen elements;

“Carbonyl” refers to double bond between carbon and oxygen atoms;

“Solvents” refers to molecular components of the electrolyte whose concentrations are higher than 10% by weight;

“Additives” are the molecular components of the electrolyte whose concentrations are lower than 10% by weight;

“Radicals” refers to atoms or molecules, either inorganic or organic, which have unpaired electrons;

“Normal alkyl” refers to unbranched, saturated hydrocarbon radicals, such as methyl, ethyl, n-propyl, n-octyl and the like;

“Branched alkyl” refers to saturated hydrocarbon radicals that contain as least one secondary or tertiary carbon designated as “branch points”, such as iso-propyl, sec-butyl, iso-pentyl, and the like;

“Skeleton” refers to the main backbone of a molecule that comprise either carbon or heteroatoms; and

“Conjugated system” refers to a skeleton that possess alternating unsaturated bonds, so that the involved pi-electrons are delocalized.

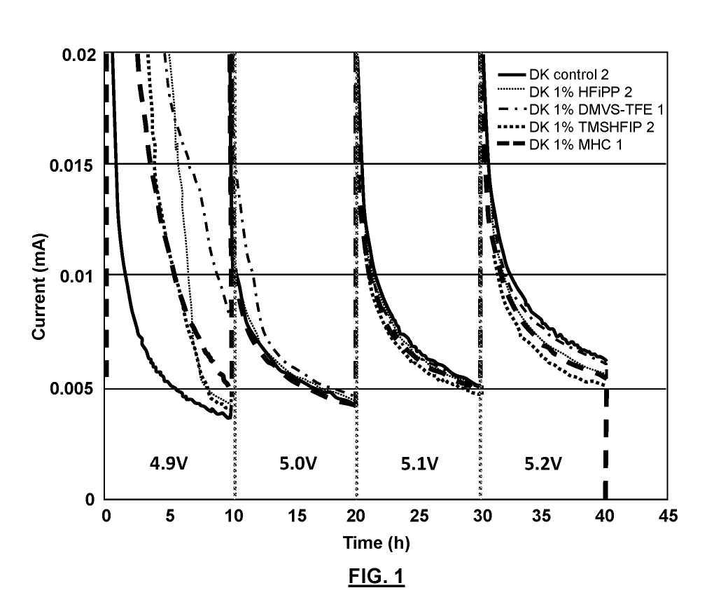

The embodiments herein provide new electrolyte solvents or additives that enable advanced battery chemistries. More specifically, the embodiments herein provide new electrolyte components, which, when used either as the bulk electrolyte solvents or co-solvents, or as additives in low concentrations, can form passivation layers on both anode and cathode surfaces, which not only are effectively protective in wide operating temperature range, but also are conductive and allow fast kinetics of the cell chemistry. Furthermore, the embodiments herein provide electrolyte solvents or additives that integrate key functional structure elements into a single molecule, so that such a molecule can form protective interphases simultaneously on both anode and cathode surfaces. The embodiments herein provide electrochemical cells and can be implemented in full batteries utilizing both the electrolyte solutions and advanced electrode materials. The devices thus developed deliver superior performances as compared with the state-of-the-art technologies. Referring now to the drawings, and more particularly to FIGS. 1 through 3, where similar reference characters denote corresponding features consistently throughout the figures, there are shown preferred embodiments.

The embodiments herein synthesize one or more organic compounds as either solvents or additives in the nonaqueous electrolytes and which integrate functional structure elements that include, but are not limited to: (1) “silicon (Si) elements” such as silane or siloxane structures; (2) “unsaturation elements” such as allyl, propargyl, vinyl and acetylenyl structures, (3) “fluorine elements” such as mono- or highly halogenated alkyls, and (4) “carbonyl elements” such as carbonic acid esters or carboxylic esters. The solvents or additives include at least two of the above functional structure elements in the same molecule. The solvents and additives include at least one “silicon element”. Moreover, the synthesized molecules are adapted as either a solvent or additive in the nonaqueous electrolytes.

According to the embodiments herein, new solvents or additives are constructed on the following skeleton as shown in structures I through V:

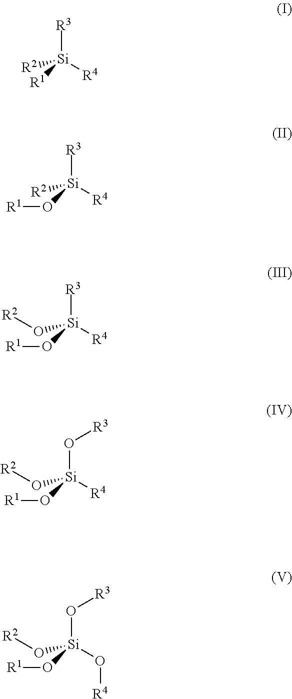

in which R^{1˜4} are independently selected from the following four groups of structural elements: (1) unsaturated radicals, such as allyls, propargyls, vinyls or acetylenyls; (2) mono- or polyhalogenated alkyl radicals such as trifluoromethyl, trifluoroethyl, hexafluoro-iso-propyl, hexafluoro-isopropyl-2-methyl, perfluoro-tert-butyl; (3) carbonyl moieties such as methyl carboxyl, or methy formyl; or (4) halogen radical such as fluorine.

In another embodiment, the solvents or additives of the embodiments herein are constructed with the structures of I through V, in which at least two of R^{1˜4} are selected from either the unsaturated substituents or the halogenated substituents.

In another embodiment, the new solvents or additives of the embodiments herein simultaneously possess at least one of either the unsaturated substituents or the halogenated substituents.

In another embodiment, the electrolyte solutions are prepared by using the solvents or additives selected from structures I through V by following the procedures known in the industry, which can be readily performed by one of ordinary skill in the art.

In another embodiment, electrochemical devices are fabricated based on the electrolyte solutions as prepared above. These devices include, but are not limited to, (1) lithium and lithium ion cells that use lithiated transition metal oxides or lithiated olivine metalphosphate as cathode, and lithium metal, lithium alloys, metal oxides or sulfides, carbonaceous materials as anode; (2) dual intercalation cells in which both cation and anion intercalate simultaneously into lattices of anode and cathode materials, respectively; (3) cells that use lithium metal, carbonaceous materials, silicon, tin and various lithium alloys as anode materials, and metal oxides, metal halides, sulfides and sulfur, and oxygen as conversion-reaction type cathode materials; (4) electrochemical double layer capacitors based on various electrode materials of high surface area; and (5) electrolysis cells that produce chemical species at extreme potentials.

The above cells are assembled according to the procedures that can be readily performed by one of ordinary skill in the art. These electrochemical devices containing the co-solvents or additives provided by the embodiments herein can afford improved performance.

The following examples are given to illustrate specific applications of the embodiments herein. However, the embodiments herein are not limited to the following.

### Example 1: Synthesis of Trimethylsilyl Propargylformate

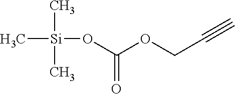

To a flask containing 32.88 g (0.256 mol) potassium trimethylsilonate (Me₃SiOK) is suspended in 100 mL anhydrous diethyl ether, and 25 mL (˜0.26 mol) propargyl chloroformate is added dropwise under stirring. The reaction is exothermic with white precipitation. Upon completion of addition, the solution is heated to reflux and then cooled down. The final product is filtered at room temperature, and filtrate is subject to repeated distillations. Final fractionation yield 80% of final product in the boiling range of 88˜95° C. The structural analysis conducted through gas chromatography-mass spectrometry (GC-MS) confirms the purity of the product to be over 99.9%, and the structure is confirmed by both MS and multi-nuclei nuclear magnetic resonance (NMR) spectroscopy.

### Example 2: Synthesis of Trimethylsilyl Hexafluoro-Isopropyl Ether

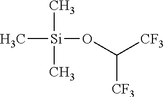

To a flask containing 0.50 mol LiH suspended in 500 mL diethylether, 0.50 mol of hexafluoro-iso-propyl alcohol is added dropwise under stirring. Upon completion of the addition and releasing of hydrogen, the solution is heated to reflux and then cooled down. 0.51 mol of trimethylsilyl chloride dissolved in 500 mL diethylether is gradually added. The reaction is exothermic, and further heating is applied to reflux the reactants in order to ensure the completion of reaction. The final product is filtered at room temperature, and filtrate is subject to repeated distillations. Final fractionation yields 70% of final product in the boiling range of 80˜85° C. The structural analysis conducted through GC-MS confirms the purity of the product to be over 99.9%, and the structure is confirmed by both MS and multi-nuclei NMR spectroscopy.

### Example 3: Synthesis of Dimethylvinylsilyl Hexafluoro-Isopropyl Ether

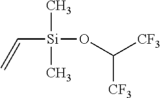

To a flask containing 5.760 g (0.724 mol) LiH suspended in 500 mL diethylether, 121.0 g (0.724 mol) of hexafluoro-iso-propyl alcohol is added dropwise under stirring. Upon completion of addition and releasing of hydrogen, the solution is heated to reflux and then cooled down. 100 mL (0.724 mol) of dimethylvinylsilyl chloride dissolved in 100 mL diethylether is gradually added. The reaction is exothermic with white precipitation, and further heating is applied to reflux the reactants in order to ensure the completion of reaction. The final product is filtered at room temperature, and filtrate is subject to repeated distillations. Final fractionation yields 58% of final product in the boiling range of 82˜83° C. The structural analysis conducted through GC-MS confirms the purity of the product to be over 99.9%, and the structure is confirmed by both MS and multi-nuclei NMR spectroscopy.

### Example 4: Synthesis of Trimethylsilyl Propargyl Ether

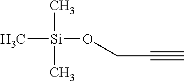

To a flask containing 0.50 mol LiH suspended in 500 mL diethylether, 0.50 mol of propargyl alcohol is added dropwise under stirring. Upon completion of addition and releasing of hydrogen, the solution is heated to reflux and then cooled down. 0.50 mol of trimethylsilyl chloride is then added dropwise under vehement stirring. The reaction is exothermic, and further heating is applied to reflux the reactants in order to ensure the completion of reaction. The final product is filtered at room temperature, and filtrate is subject to repeated distillations. Final fractionation yields 78% of final product in the boiling range of 98˜105° C. The structural analysis conducted through GC-MS confirms the purity of the product to be over 99.9%, and the structure is confirmed by both MS and multi-nuclei NMR spectroscopy.

### Example 5: Synthesis of Dimethylvinylsilyl 2,2,2-Trifluoroethyl Ether

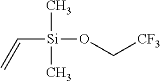

To a flask containing 0.50 mol LiH suspended in 500 mL diethylether, 0.50 mol of 2,2,2-trifluoroethanol is added dropwise under stirring. Upon completion of addition and releasing of hydrogen, the solution is heated to reflux and then cooled down. Then, 0.50 mol of dimethylvinylsilyl chloride dissolved in 100 mL diethylether is gradually added under vehement stirring. The reaction is exothermic, and further heating is applied to reflux the reactants in order to ensure the completion of reaction. The final product is filtered at room temperature, and filtrate is subject to repeated distillations. Final fractionation yields 70% of final product in the boiling range of 98˜100° C. The structural analysis conducted through GC-MS confirms the purity of the product to be over 99.9%, and the structure is confirmed by both MS and multi-nuclei NMR spectroscopy.

### Example 6: Preparation of Electrolyte Solutions

This example summarizes a general procedure for the preparation of electrolyte solutions comprising the solvents or additives provided by the embodiments herein, whose synthesis has been disclosed in Examples 1 through 5. Both the concentration of the lithium salts and the relative ratios between the solvents or additives can be varied according to specific needs.

The electrolyte solutions is prepared under the moisture-free environment to have the following composition: one lithium salt or the mixture of lithium salts, and a solvent system that either comprises a neat solvent selected from structures I through V, with or without one or more additives selected from structures I through V.

The lithium salts selected include, but are not limited to, lithium hexafluorophosphate, lithium hexafluoroarsenate, lithium tetrafluoroborate, lithium perfluoroalkylfluorophosphate, lithium perfluoroalkylfluoroborate, lithium bis(trifluoromethanesulfonyl)imide, lithium bis(perfluoroethanesulfonyl)imide, lithium bis(oxalato)borate, and lithium (difuorooxalato)borate.

The solvents or additives are selected from the solvents or additives that are provided by the embodiments herein and the commonly-used nonaqueous electrolyte solvents include, but are not limited to, cyclic or acylic carboxylic esters, such as ethyl acetate and gamma-butyrolactone, cyclic or acylic diesters of carbonic acids, such as ethylene carbonate and dimethyl carbonate, fluorinated cyclic or acylic diesters of carbonic acids, such as fluoroethylene carbonate, 1,1,1-trifluoroethyl methyl carbonate, nitriles such as acetonitrile and 3-(2,2,2-trifluoroethoxy)propionitrile, or the mixtures thereof. The resultant electrolyte solution should contain at least one of those solvents or additives that are provided by the embodiments herein and are as described in structures I through V.

Typically, the solvent or solvent mixtures with or without the additives are weighed and mixed according to specific ratios, then the lithium salt or mixture of lithium salts are weighed and dissolved in the above solvent or solvent mixtures.

As non-limiting examples, Table 1 lists selected electrolyte solutions formulated by using the solvents and additives provided by the embodiments herein.

TABLE 1

| Salt | | |
|---|---|---|
| Concentration | Solvent | Additive |
| (M) | Ratio (by Weight) | (Concentration by Weight) |
| LiPF₆ | Ethylene carbonate/ | trimethylsilyl |
| 1.0 m | dimethyl carbonate | propargylformate (1%) |
| LiPF₆ | Ethylene carbonate/ | trimethylsilyl propargylformate |
| 1.0 m | dimethyl carbonate | (1%) + vinyl carbonate (1%) |
| LiPF₆ | Ethylene carbonate/ | trimethylsilyl hexafluoro- |
| 1.0 m | dimethyl carbonate | isopropyl ether (0.5%) |
| LiPF₆ | Propylene Carbonate | dimethylvinylsilyl hexafluoro- |
| 1.0 m | | isopropyl ether (1%) |
| LiPF₆ | Propylene Carbonate | trimethylsilyl propargylformate |
| 1.0 m | | (1%) + vinyl carbonate (1%) |
| LiPF₆ | Ethylene carbonate/ | trimethylsilyl propargylformate |
| 1.0 m | dimethyl carbonate | (0.5%) + dimethylvinylsilyl |
| | | hexafluoro-isopropyl ether |
| | | (0.5%) |
| LiPF₆ | Ethylene carbonate/ | trimethylsilyl |
| 1.0 m | dimethyl carbonate | propargyl ether (1%) |
| LiPF₆ | Ethylene carbonate/ | dimethylvinylsilyl 2,2,2- |
| 1.0 m | dimethyl carbonate | trifluoroethyl ether (1%) |

### Example 7: Fabrication of a Lithium Ion Cell

This example summarizes the general procedure of the assembly of a lithium ion cell. Typically, a piece of Celgard® polypropylene separator is sandwiched between an anode composite film that is based on graphitic carbon and coated on copper foil, and a cathode composite film that is based on either lithiated transition metal oxides, lithiated metalphosphate or mixture thereof and that is coated on aluminum foil. The lithium ion cell is then activated by soaking the separator with the electrolyte solutions as prepared in Example 6, and sealed with appropriate means.

### Example 8: Fabrication of a Dual Ion Intercalation Cell

This example summarizes the general procedure of the assembly of dual ion intercalation cells. Typically, a piece of Celgard® polypropylene separator is sandwiched between an anode composite film that is based on graphitic carbon that is coated on copper foil, and a cathode composite film that is also based on graphitic carbon but coated on aluminum foil. The lithium ion cell is then activated by soaking the separator with the electrolyte solutions as prepared in Example 6, and sealed with appropriate means.

### Example 9: Fabrication of a Lithium Sulfur Cell

This example summarizes the general procedure of the assembly of electrochemical double layer capacitors. Typically, a piece of Celgard® polypropylene separator is sandwiched between a pair of composite electrodes based on lithium metal and sulfur confined in nano-structured carbon host. The separator is then activated with the electrolyte solutions as prepared in Example 6, and sealed with appropriate means.

### Example 10: Testing of the Electrochemical Cells

This example summarizes the general procedure of testing the electrochemical devices assembled in Examples 7 through 9. The half cells of lithium ion anode and cathode are subject to both voltammetric and galvanostatic cyclings, and the full lithium ion cells, dual intercalation cells and electrochemical double layer capacitors are subject to galvanostatic cyclings followed by potentiostatic floating. Standard potentiostat/galvanostat and battery testers are employed.

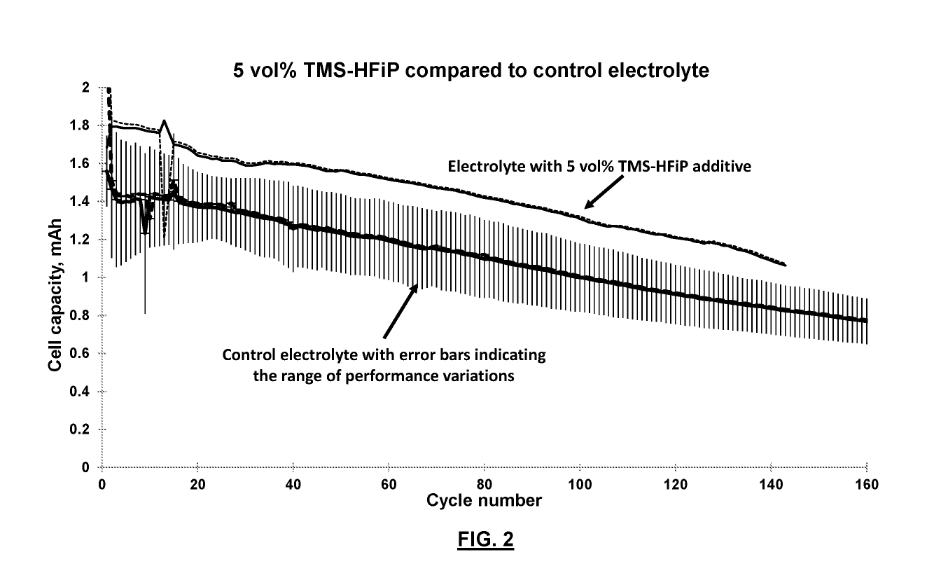

As example for the purpose of illustration, the galvanostic cycling results of anode half cells in two selected electrolytes are shown in FIG. 1. More particularly, FIG. 1 is a graph illustrating the results of “floating tests” of different electrolyte solutions in a high voltage Li-ion cell comprising graphite as an anode and LiNi_{0.5}Mn_{1.5}O₄ as a cathode. FIG. 1 demonstrates the effectiveness of the silane-based additive TMS-HFIP (the compound detailed in Example 2 above). In FIG. 1, TMS-HFIP electrolytes have a lower current response at high voltages, especially at 5.1V and 5.2V, than electrolytes with other additives and the control electrolyte. The reduced current is indicative of reduced electrolyte oxidation. FIG. 2 is a graph illustrating the results of “cycling tests” of different electrolyte solutions in a high voltage Li-ion cell comprising graphite as an anode and LiNi_{0.5}Mn_{1.5}O₄ as a cathode. In FIG. 2, the TMS-HFIP electrolyte displays a higher capacity than the expected range of the control electrolyte through at least 140 charge and discharge cycles. In the case of FIG. 2, the enhanced passivation of electrodes afforded by the reactions of TMS-HFIP allow the cell to use its maximum rated capacity, which is normally not achieved by standard electrolyte formulations.

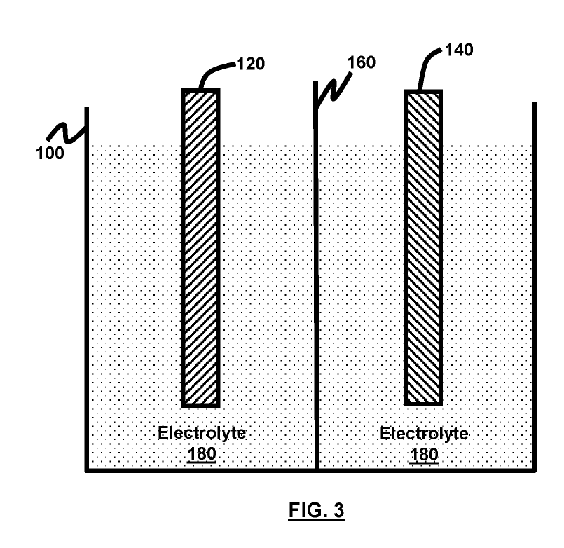

FIG. 3 illustrates an electrochemical cell 100 according to an embodiment herein. The electrochemical cell 100 comprises a negative electrode 120 comprising any of a metal, a metal alloy, and an electrode active material; a positive electrode 140 comprising an electrode active material; a membrane 160 separating the negative electrode 120 from the positive electrode 140; and a nonaqueous electrolyte solvent or additive 180.

The embodiments herein provide a new family of polar and aprotic organic molecules that are rationally designed and synthesized in such a manner that various key functional structure elements are synthetically integrated into a single molecule so that interphasial chemistries on both cathode and anode surfaces are simultaneously catered to with high efficiencies. When serving as components in the nonaqueous electrolytes, the solvents or additives provided by the embodiments herein can eliminate irreversible losses, mitigate impedance growth and enable the most challenging chemistries with high efficiency and long cycle life. The advanced battery chemistries employing cathode materials of either very high voltage or very high capacities, or anode materials with high capacities accompanied with large volume changes can benefit from the presence of the electrolyte solvents or additives provided by the embodiments herein.

The advanced battery chemistries include, but are not limited to, Li-ion batteries of very high voltages (>4.5 V) such as LiNi_{0.5}Mn_{1.5}O₂, LiCoPO₄ or LiNiPO₄, or anode or cathode materials that can provide extremely high capacities but meanwhile experiencing extremely dynamic phase changes, such as conversion-reaction-type cathode materials based on metal oxides or halides, Li/oxygen chemistries, sulfur-based cathode materials as well as anode materials based on alloy-type mechanism such as silicon or tin.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An electrochemical cell comprising:
a negative electrode comprising any of a metal, a metal alloy, and an electrode active material;
a positive electrode comprising an electrode active material;
a membrane separating said negative electrode from said positive electrode; and
a nonaqueous electrolyte solvent or additive comprising molecules having a structure of any of formulas I through V: 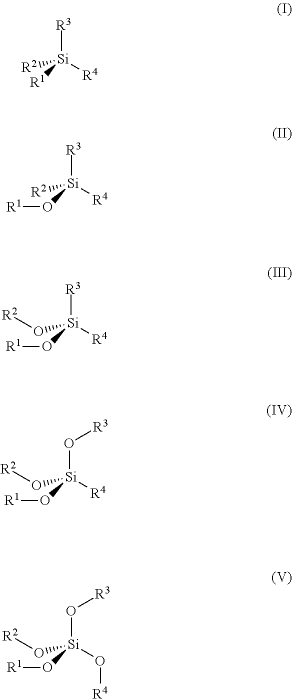
wherein R^{1˜4} are independently selected from the following four groups of structural elements: (1) unsaturated radicals, (2) mono- or polyhalogenated alkyl radicals; (3) carbonyl moieties; or (4) halogen radicals.

2. The electrochemical cell of claim 1, wherein said cations comprise any of Li⁺, Na⁺, Mg²⁺, Ca²⁺, and Al³⁺.

3. The electrochemical cell of claim 1, wherein said unsaturated radicals comprise any of allyls, propargyls, vinyls, and acetylenyls.

4. The electrochemical cell of claim 1, wherein said mono- or polyhalogenated alkyl radicals comprise any of trifluoromethyl, trifluoroethyl, hexafluoro-iso-propyl, hexafluoro-isopropyl-2-methyl, and perfluoro-tert-butyl.

5. The electrochemical cell of claim 1, wherein said carbonyl moieties comprise any of methyl carboxyl and methy formyl.

6. The electrochemical cell of claim 1, wherein said halogen radicals comprise fluorine.

7. The electrochemical cell of claim 1, wherein said nonaqueous electrolyte solvent or additive only comprises said molecules.

8. The electrochemical cell of claim 1, further comprising a cosolvent mixed with said nonaqueous electrolyte solvent or additive, wherein said cosolvent comprises any of cyclic and acyclic carbonates and carboxylic esters, and fluorinated cyclic and acyclic carbonates and carboxylic esters.

9. The electrochemical cell of claim 8, further comprising any of ethylene carbonate, propylene carbonate, vinyl carbonate, dimethyl carbonate, diethyl carbonate, ethylmethyl carbonate, γ-butyrolactone, methyl butyrate, ethyl butyrate, and mixtures thereof.

10. The electrochemical cell of claim 8, further comprising any of fluoroethylene carbonate and 1,1,1-trifluoroethylmethyl carbonate.

11. The electrochemical cell of claim 2, wherein said Li comprises any of lithium hexafluorophosphate, lithium fluoro(perfluoroalkyl)phosphate, lithium tetrafluroborate, lithium hexafluroarsenate, lithium perchlorate, lithium tetrahloaluminate, lithium tris(trifluoromethanesulfonyl)methide, lithium perfluoroalkylsulfonate, lithium arylsulfonate, lithium bis(oxalato)borate, lithium difluoro(oxalato)borate, and mixtures thereof.

12. The electrochemical cell of claim 1, wherein said negative electrode comprises an active material comprising any of a lithium metal and a lithium alloy with other metals comprising any of silicon, tin, carbonaceous materials with various degree of graphitization, lithiated metal oxides, and chalcogenides.

13. The electrochemical cell of claim 1, wherein said positive electrode comprises an active material comprising any of transition metal oxides, metal halides, metalphosphates, chalcogenides, and carbonaceous materials with various degree of graphitization, sulfur-based cathode materials embedded or confined in various meso- or micropores of carbon hosts.

14. The electrochemical cell of claim 8, wherein any of said nonaqueous electrolyte solvent or additive, and said cosolvent comprises a concentration of approximately 0.005% to 100% with respect to a total solvent weight.

15. The electrochemical cell of claim 2, wherein said Li⁺, Na⁺, Mg²⁺, Ca²⁺, and Al³⁺ comprise a concentration of approximately 0.5-3.0 mole/liter.

16. The electrochemical cell of claim 1, wherein said negative electrode reversibly intercalates/de-intercalates cations voltage potentials less than 2V.

17. The electrochemical cell of claim 1, wherein said positive electrode reversibly intercalates/de-intercalates cations and experiences reversible conversion-reactions.

18. The electrochemical cell of claim 1, wherein said structural elements comprise a structure of any of formulas VI through X:

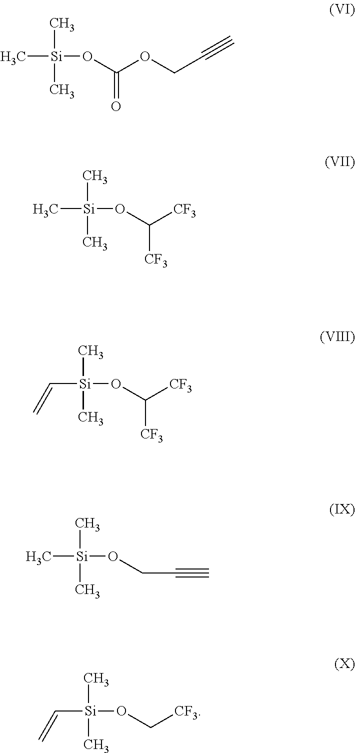

19. The electrochemical cell of claim 1, wherein said membrane comprises a porous polyolefin separator.

20. The electrochemical cell of claim 1, wherein said membrane comprises a gellable polymer film.
